(19) United States
(12) Patent Application Publication
(10) Pub. No.: US 2014/0202730 A1
(43) Pub. Date: Jul. 24, 2014

(54) SOFT DILUTE-COPPER ALLOY INSULATED TWISTED WIRE AND COIL

(71) Applicant: Hitachi Metals, Ltd., Tokyo (JP)

(72) Inventors: Keisuke Fujito, Mito (JP); Seigi Aoyama, Kitaibaraki (JP); Toru Sumi, Hitachi (JP); Hideyuki Sagawa, Tokai-mura (JP)

(73) Assignee: Hitachi Metals, Ltd., Tokyo (JP)

(21) Appl. No.: 14/075,285

(22) Filed: Nov. 8, 2013

(30) Foreign Application Priority Data
Jan. 18, 2013 (JP) 2013-007604

(51) Int. Cl. H01B 1/02

(52) U.S. Cl. CPC H01B 1/026
USPC 174/110 R

(57) ABSTRACT

A soft dilute-copper alloy insulated twisted wire includes a plurality of insulated wires twisted together and each including a conductor and an insulating cover layer thereon. The conductor includes a soft dilute-copper alloy wire including a soft dilute-copper alloy material including an additional element selected from the group consisting of Ti, Mg, Zr, Nb, Ca, V, Ni, Mn and Cr with a balance consisting a copper and an inevitable impurity. An average crystal grain size in a region from a surface of the soft dilute-copper alloy wire to a depth of at least 20% of a wire diameter is not more than 20 μm.

The present application is based on Japanese patent application No. 2013-007604 filed on Jan. 18, 2013, the entire contents of which are incorporated herein by reference.

### BACKGROUND OF THE INVENTION

1. Field of the Invention

The invention relates to a soft dilute-copper alloy insulated twisted wire for high-frequency transmission and, in particular, to a soft dilute-copper alloy insulated twisted wire used as a litz wire. Also, the invention relates to a coil using the soft dilute-copper alloy insulated twisted wire.

2. Description of the Related Art

With the recent development of science and technology, electricity demand is more and more increasing. Electric motorization is progressively adopted even in the motive power field conventionally using fossil fuel as a power source, and expectation for hybrid and electric cars using a motor is growing especially in the automotive field. For electrical motorization of vehicles, batteries for storing electricity to be an energy source thereof and power supply methods for supplying electricity to such batteries are still being technologically developed. Currently, batteries are charged mainly by connecting a cable and a connector but it is considered that contactless power supply will take over in the future.

The contactless power supply is based on the principle of electromagnetic induction, use of energy transmission by radio wave, or techniques using electromagnetic induction or electromagnetic field resonance. The technique of using electromagnetic induction is currently more common.

A coil is required for the contactless power supply by electromagnetic induction or electromagnetic field resonance and efficiency is increased by passing a high frequency current through the coil. It is necessary to pass a large current through the coil to increase power output but merely increasing a conductor diameter only causes a decrease in efficiency since the current flows only in the vicinity of the conductor surface due to skin effect at increased frequency. Therefore, a method is used in which thin wires are arranged in parallel to increase surface area so that the high frequency current flows efficiently.

So far, efficient power supply bodies are manufactured such that copper or aluminum, which is a metal having high conductivity and is easy to handle, is selected as a material used for a coil, thin wires formed of such a material are each covered with a thin insulating cover and are twisted together to form a litz wire which is further formed into a coil.

Thus, high conductive materials which allow easy reduction of diameter and are soft but highly strong are desired in order to manufacture coils for high-efficient contactless power supply.

As a measure to meet such demand, a coil conductor using a hollow conductor is describe in JP-A-2011-124129. Meanwhile, a coil conductor using an aluminum alloy wire is described in JP-A-2011-162826.

### SUMMARY OF THE INVENTION

The litz wire has the following problems.

When comparing the litz wire to a single conductor having the same cross sectional area, work hardening is likely to progress in the litz wire due to its structure in which thin wires each covered with an insulating cover are twisted together, and heat treatment to remove work hardening, which needs to be carried out at not more than heat resistant temperature of an insulating film and thus cannot be carried out at high temperature, takes long time, resulting in that the process becomes more complicated and takes longer time. Also, it is considered that a further process of bending to shape into a coil further increases the work hardening.

In JP-A-2011-124129, use of hollow wire is described but it is inherently difficult to manufacture the hollow wire.

Meanwhile, weight reduction and flexibility are certainly obtained by using aluminum for a conductor as described in JP-A-2011-162826. However, it is necessary to increase volume in order to have the same resistance and, in addition to this, it is also necessary to take measures such as increasing a surface area, i.e., increasing the number of wires connected in parallel since it becomes susceptible to the skin effect at high frequency, which results in a significant increase in size of device.

It is an object of the invention to provide a soft dilute-copper alloy insulated twisted wire formed of soft dilute-copper alloy wires with high conductivity, high tensile strength and high elongation percentage even as a soft material, and also small hardness, as well as a coil using the soft dilute-copper alloy insulated twisted wire.

(1) According to one embodiment of the invention, a soft dilute-copper alloy insulated twisted wire comprises a plurality of insulated wires twisted together and each comprising a conductor and an insulating cover layer thereon,

wherein the conductor comprises a soft dilute-copper alloy wire comprising a soft dilute-copper alloy material comprising an additional element selected from the group consisting of Ti, Mg, Zr, Nb, Ca, V, Ni, Mn and Cr with a balance consisting a copper and an inevitable impurity, and

wherein an average crystal grain size in a region from a surface of the soft dilute-copper alloy wire to a depth of at least 20% of a wire diameter is not more than 20 μm.

In the above embodiment (1) of the invention, the following modifications and changes can be made.

(i) The soft dilute-copper alloy material comprises more than 2 mass ppm of oxygen and not less than 2 mass ppm and not more than 12 mass ppm of sulfur.

(ii) The soft dilute-copper alloy material has a tensile strength of not less than 210 MPa, an elongation percentage of not less than 15% and a Vickers hardness of not more than 65 Hv.

(iii) The soft dilute-copper alloy material has a conductivity of not less than 98% IACS.

(iv) The soft dilute-copper alloy material comprises not less than 4 mass ppm and not more than 55 mass ppm of Ti as the additive element and more than 2 mass ppm and not more than 30 mass ppm of oxygen.

(v) A plurality of the soft dilute-copper alloy wires each comprising an insulating cover layer are twisted together and another insulation cover layer is further formed on the outer periphery thereof.

(2) According to another embodiment of the invention, a coil comprises the soft dilute-copper alloy insulated twisted wire according to the above embodiment (1) and a coil shape.

According to one embodiment of the invention, a soft dilute-copper alloy material containing a specific additional element such as Ti with the balance of copper can provide a crystal structure in which an average crystal grain size from the surface to a depth of 20% of the wire diameter is not more than 20 μm. Therefore, excellent effects are obtained, such that it is possible to provide a soft dilute-copper alloy insulated twisted wire formed using soft dilute-copper alloy wires having conductivity in combination with high tensile strength and high elongation percentage which are achieved by micronizing crystal grains in a surface layer, and the soft dilute-copper alloy insulated twisted wire thus can be provided for various product areas such as high frequency conductor or power transmission conductor.

### BRIEF DESCRIPTION OF THE DRAWINGS

The present invention will be explained in more detail in conjunction with appended drawings, wherein:

FIG. 1 is a cross sectional view showing an example of a soft dilute-copper alloy insulated twisted wire in the present invention;

FIG. 2 is a photograph showing a cross section across-the-width of Example Material 1 having a diameter of 0.26 mm in the invention;

FIG. 3 is a photograph showing a cross section across-the-width of Comparative Material 1 having a diameter of 0.26 mm;

FIG. 4 is an explanatory diagram illustrating a method of measuring an average crystal grain size in a surface layer of a sample having a diameter of 0.26 mm in the invention;

FIG. 5 is a photograph showing a cross section across-the-width of Example Material 2 having a diameter of 0.26 mm in the invention;

FIG. 6 is a photograph showing a cross section across-the-width of Comparative Material 2 having a diameter of 0.26 mm;

FIG. 7 is a graph showing a relation between an elongation percentage and hardness of Example Material 3 in the invention and that in Comparative Material 3;

FIG. 8 is a graph showing a relation between tensile strength and hardness of Example Material 3 in the invention and that in Comparative Material 3;

FIG. 9 is a photograph showing a cross section across-the-width of Example Material 3 having a diameter of 0.05 mm in the invention;

FIG. 10 is a photograph showing a cross section across-the-width of Comparative Material 3 having a diameter of 0.05 mm; and

FIG. 11 is a schematic view showing a method of measuring an average crystal grain size in a surface layer in the invention.

### DETAILED DESCRIPTION OF THE PREFERRED EMBODIMENT

Although an embodiment of the invention will be described below, the invention according to claims is not to be limited to the embodiment below. Further, it should be noted that all combinations of the features described in the embodiment are not necessary to solve the problem of the invention.

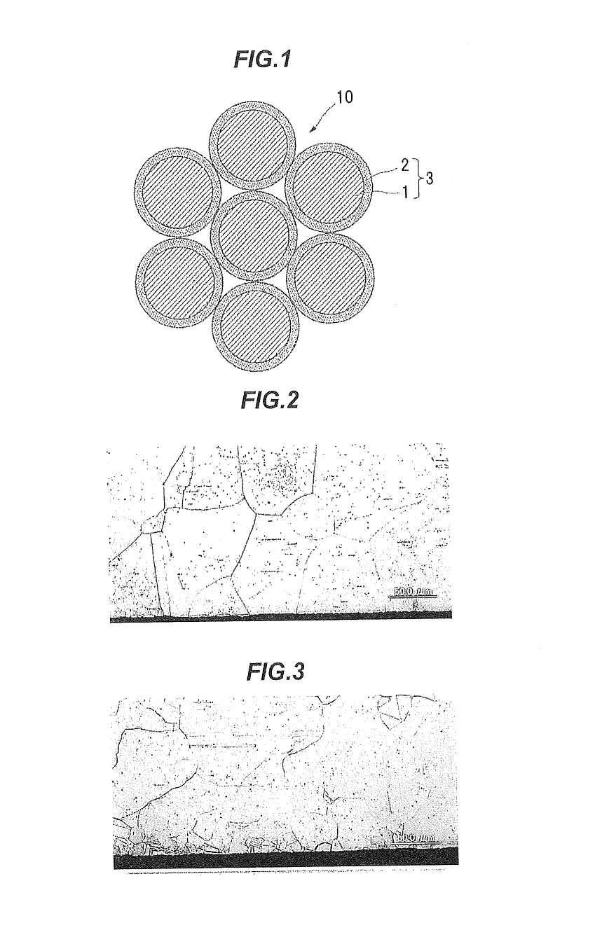

In the invention, as shown in FIG. 1, a conductor 1 constructed from a soft dilute-copper alloy wire formed by drawing a soft dilute-copper alloy material is covered with an insulating cover layer 2 typified by enamel to form a soft dilute-copper alloy insulated wire 3, and then, plural soft dilute-copper alloy insulated wires 3 are bundled and twisted together, thereby forming a soft dilute-copper alloy insulated twisted wire 10.

In addition, another insulating cover layer may be further formed on an outer periphery of the soft dilute-copper alloy insulated twisted wire 10 even though it is not shown in the drawing.

The soft dilute-copper alloy insulated twisted wire 10 of the invention can be used as a litz wire which is effective to reduce the skin effect, etc., caused by high frequency, and a contactless power supply coil can be formed by coiling the litz wire.

The invention is directed to a soft dilute-copper alloy wire and a soft dilute-copper alloy insulated twisted wire formed by twisting plural soft dilute-copper wires each having an insulating cover layer formed thereon. The soft dilute-copper alloy wire is formed of a soft dilute-copper alloy material containing an additional element selected from the group consisting of Ti, Mg, Zr, Nb, Ca, V, Ni, Mn and Cr with the balance comprising copper, and an average crystal grain size from the surface of the soft dilute-copper alloy wire toward inside up to a depth of 20% of the wire diameter is not more than 20 μm.

It is preferable to have a crystal structure in which an average crystal grain size in a surface layer form the surface toward inside up to a depth of 5 to 20% of a wire diameter is 5 to 15 μm and an average crystal grain size of further inside is 50 to 100 μm.

In the invention, the soft dilute-copper alloy insulated twisted wire formed using the soft dilute-copper alloy wires is formed of a soft dilute-copper alloy material containing more than 2 mass ppm of oxygen and having a tensile strength of not less than 210 MPa, an elongation percentage of not less than 15%, a Vickers hardness of not more than 65 Hv and a conductivity of not less than 98% IACS, and is especially preferably formed of a soft dilute-copper alloy material containing 4 mass ppm to 55 mass ppm of Ti as the additive element, not less than 2 mass ppm and not more than 12 mass ppm of sulfur and more than 2 mass ppm and not more than 30 mass ppm of oxygen with copper as the balance.

Composition of Soft Dilute-Copper Alloy Material

### (1) Additive Elements

The soft dilute-copper alloy material in the invention contains an additional element selected from the group consisting of Ti, Mg, Zr, Nb, Ca, V, Ni, Mn and Cr with copper and inevitable impurities as the balance.

The elements selected as additive elements from the group consisting of Ti, Mg, Zr, Nb, Ca, V, Ni, Mn and Cr are active elements prone to bind to other elements and are especially prone to bind to S (sulfur), which allows S to be trapped and matrix of a copper base material to be highly purified. One or more additive elements may be contained. In addition, other elements and inevitable impurities which do not adversely affect the properties of an alloy may be contained in the alloy.

In addition, more than 2 mass ppm and not more than 30 mass ppm of the oxygen content is favorable in the below-described preferred embodiment, and more than 2 mass ppm and not more than 400 mass ppm of oxygen can be contained within a range providing the properties of the alloy, depending on the added amount of the additive elements and the S content.

### (2) Composition Ratio

The total of one or two or more of Ti, Ca, V, Ni, Mn, and Cr contained as an additional elements is 4 to 55 mass ppm, particularly preferably 10 to 20 mass ppm. The content of Mg is 2 to 30 mass ppm, particularly preferably 5 to 10 mass ppm. The contents of Zr and Nb are 8 to 100 mass ppm, particularly preferably 20 to 40 mass ppm.

In addition, more than 2 mass ppm and not more than 30 mass ppm of the oxygen content is favorable in the below-described preferred embodiment, 5 to 15 mass ppm is particularly preferable, and more than 2 mass ppm and not more than 400 mass ppm of oxygen can be contained within a range providing the properties of the alloy, depending on the added amount of the additive elements and the S content.

The S content is 2 to 12 mass ppm, particularly preferably 3 to 8 mass ppm.

The soft dilute-copper alloy material in the invention is preferably formed as a soft copper material which satisfies a conductivity of not less than 98% IACS (IACS: International Annealed Copper Standard, conductivity is defined as 100% when resistivity is 1.7241×10⁻⁸ Ωm), preferably not less than 100% IACS, more preferably not less than 102% IACS.

In the invention, in order to obtain a soft copper material having a conductivity of not less than 98% IACS, a soft dilute-copper alloy material in which pure copper as a base material with inevitable impurities is combined with 3 to 12 mass ppm of sulfur, more than 2 mass ppm and not more than 30 mass ppm of oxygen and 4 to 55 mass ppm of titanium is used to manufacture a wire rod (a roughly drawn wire).

Here, in order to obtain a soft copper material having a conductivity of not less than 100% IACS, it is preferable to use a soft dilute-copper alloy material in which pure copper as a base material with inevitable impurities contains 2 to 12 mass ppm of sulfur, more than 2 mass ppm and not more than 30 mass ppm of oxygen and 4 to 37 mass ppm of titanium.

In addition, a soft dilute-copper alloy material having a conductivity of not less than 102% IACS preferably contains pure copper as a base material with inevitable impurities in combination with 3 to 12 mass ppm of sulfur, more than 2 mass ppm and not more than 30 mass ppm of oxygen and 4 to 25 mass ppm of titanium.

Sulfur is generally introduced into copper during manufacturing of electrolytic copper in the industrial production of pure copper and it is therefore difficult to adjust the sulfur to be not more than 3 mass ppm. The upper limit of the sulfur concentration in general-purpose electrolytic copper is 12 mass ppm.

More than 2 mass ppm and not more than 30 mass ppm of oxygen is contained, which means that so-called low-oxygen copper (LOC) is intended to be used in the present embodiment.

The oxygen concentration is controlled to be more than 2 mass ppm since hardness of copper conductor is less likely to be reduced when the oxygen concentration is lower than 2 mass ppm. On the other hand, flaws are likely to be generated on the surface of the copper conductor during the hot rolling process when the oxygen concentration is high, hence, controlled to be not more than 30 mass ppm.

### (3) Crystal Structure

The soft dilute-copper alloy insulated twisted wire formed using the soft dilute-copper alloy wires in the invention has a crystal structure in which an average crystal grain size from the wire surface toward inside of the copper wire up to a depth of 20% of the wire diameter is not more than 20 μm. Preferably, the average crystal grain size in a surface layer, which is 5 to 20% of a wire diameter form the surface toward inside, is 5 to 15 μm and an average crystal grain size of further inside is 50 to 100 μm.

This is because improvement in tensile strength or elongation of the material can be expected due to presence of fine crystals especially in the surface layer. The reason for this is considered that the local strain introduced near a grain boundary due to tensile deformation becomes smaller as the crystal grain size becomes finer, this contributes to relieve stress concentration at grain boundary, and accordingly, the stress concentration at grain boundary is reduced and grain boundary fracture is suppressed.

In addition, in the invention, the crystal structure in which the average crystal grain size from the surface of the soft dilute-copper alloy wire toward inside up to a depth of 20% of the wire diameter is not more than 20 μm does not exclude an aspect in which a fine crystal layer is present in a region beyond the depth of 20% of the wire diameter and closer to the center of the wire rod, as long as the effects of the invention are obtained.

### (4) Dispersed Substance

Dispersed particles in the soft dilute-copper alloy material are preferably small in size, and a large amount of dispersed particles is preferably dispersed in the soft dilute-copper alloy material. The reason for this is that the dispersed particles have a function as a precipitation site of sulfur and the precipitation site is required to be small in size and large in number.

In detail, in the soft dilute-copper alloy insulated twisted wire formed using the soft dilute-copper alloy wires, sulfur and, especially, titanium as an additive element are contained as a compound having TiO, TiO₂, TiS or Ti—O—S bond or an aggregate of the compound having TiO, TiO₂, TiS or Ti—O—S bond and the remaining Ti and S are contained as solid solution. The same as titanium applies to other additive elements. Formation of dispersed particles and precipitation of sulfur onto the dispersed particles improve purity of matrix of the copper base material and contribute to improvement in conductivity and reduction in hardness of the material.

### (5) Hardness, Elongation and Tensile Strength of Soft Dilute-Copper Alloy Material

The soft dilute-copper alloy material in the invention is required to have an excellent balance between tensile strength and elongation percentage. It is because, for example, in case of conductors having the same elongation percentage value, wire breakage caused by stress application such as bending or twisting at the time of forming a twisted wire can be suppress in the conductor having higher tensile strength.

In addition, it is desirable that the soft dilute-copper alloy material in the invention have elongation percentage equal to or greater than that of an oxygen-free copper wire treated by annealing and a tensile strength value 2 MPa or more higher than that of the oxygen-free copper wire.

Method of Manufacturing Soft Dilute-Copper Alloy Insulated Twisted Wire

The following is a method of manufacturing the soft dilute-copper alloy insulated twisted wire formed using the soft dilute-copper alloy wires in the invention.

An example in which Ti is selected as an additive element will be described.

Firstly, a soft dilute-copper alloy material containing Ti is prepared as a raw material of the soft dilute-copper alloy insulated twisted wire formed using the soft dilute-copper alloy wires (raw material preparation step). Next, the soft dilute-copper alloy material is formed into molten metal at a molten copper temperature of not less than 1100° C. and not more than 1320° C. (molten metal manufacturing step). Then, a wire rod is formed of the molten metal (wire rod forming step). Following this, the wire rod is hot-rolled at a temperature of not less than 550° C. and not more than 880° C. (hot-rolling step). Furthermore, the wire rod after the hot-rolling step is drawn and heat-treated (wire drawing step and heat treatment step). Applicable heat treatment methods are running annealing using a tubular furnace and electric annealing using resistance heat, etc. Other than the above, batch type annealing is also applicable. As a result, the soft dilute-copper alloy material in the invention is produced.

Here, the soft dilute-copper alloy material containing not less than 2 mass ppm and not more than 12 mass ppm of sulfur, more than 2 mass ppm and not more than 30 mass ppm of oxygen and not less than 4 mass ppm and not more than 55 mass ppm of titanium is used for manufacturing the soft dilute-copper alloy insulated twisted wire formed using the soft dilute-copper alloy wires.

The inventors examined the following two measures in order to realize reduction in hardness of the copper conductor and improvement in conductivity of the copper conductor. The use of combination of the two measures in the manufacturing of copper wire rod allows the soft dilute-copper alloy insulated twisted wire formed using the soft dilute-copper alloy wires in the invention to be obtained.

Firstly, the first measure is to make molten copper in a state that titanium (Ti) is added to pure copper having an oxygen concentration of more than 2 mass ppm. It is considered that particles of TiS, titanium oxide (e.g., TiO₂) and Ti—O—S are formed in the molten copper.

Next, the second measure is to set a temperature during the hot-rolling step to a lower temperature (880 to 550° C.) than the temperature under the typical manufacturing conditions of copper (e.g., 950 to 600° C.) so that dislocation is introduced into copper for easy precipitation of sulfur (S). Such temperature setting allows S to be precipitated on the dislocation or to be precipitated using titanium oxide (TiO₂) as a nucleus.

The sulfur in the copper is crystallized and precipitated by the first and second measures and it is thereby possible to obtain a copper wire rod having desired softness and desired conductivity after the cold wire drawing process.

Using a SCR continuous casting and rolling machine, the soft dilute-copper alloy insulated twisted wire formed using the soft dilute-copper alloy wires in the invention can be stably produced in a wide range of production with less generation of surface flaws.

A wire rod is manufactured by the SCR continuous casting and rolling where a compression ratio for processing an ingot rod is 90% (30 mm) to 99.8% (5 mm). The conditions for manufacturing an 8 mm-diameter wire rod at a compression ratio of 99.3% are employed as an example.

The molten copper temperature in a melting furnace is preferably controlled to be not less than 1100° C. and not more than 1320° C. The molten copper temperature is controlled to be not more than 1320° C. since there is a tendency that a blow hole is increased, a flaw is generated and a particle size is enlarged when the temperature is high. The temperature of the molten copper is controlled to be not less than 1100° C. because otherwise copper is likely to solidify and the manufacturing is not stable, however, molten copper temperature is desirably as low as possible.

Preferably, the temperature during the hot-rolling step is controlled to be not more than 880° C. at the initial roll and not less than 550° C. at the final roll.

Unlike the typical manufacturing conditions of pure copper, these casting conditions aim to further decrease a solid solubility limit which is an activation energy of crystallization of sulfur in the molten copper and precipitation of the sulfur during the hot rolling.

In addition, the typical temperature during the hot-rolling step is not more than 950° C. at the initial roll and not less than 600° C. at the final roll, however, in order to further decrease the solid solubility limit, the temperature in the invention is desirably set to not more than 880° C. at the initial roll and not less than 550° C. at the final roll.

The reason for setting the temperature at the final roll to not less than 550° C. is that, when the temperature is less than 550° C., wire rods obtained have many flaw and copper conductors manufactured therefrom cannot be treated as finished products. The temperature during the hot-rolling step is controlled to be not more than 880° C. at the initial roll and not less than 550° C. at the final roll and is preferably as low as possible. Such temperature setting improves purity of the matrix of the soft dilute-copper alloy insulated twisted wire formed using the soft dilute-copper alloy wires, which allows conductivity to be improved and hardness to be reduced.

Pure copper as a base material is preferably melted in a shaft furnace and is then poured into a gutter in a reduced state. That is, to stably manufacture a wire rod, it is preferable that casting be carried out under reductive gas (e.g., CO gas) atmosphere while controlling concentrations of sulfur, titanium and oxygen of a dilute alloy, followed by the rolling of the material. Mixture of copper oxide and/or particle larger than a predetermined size deteriorates quality of copper conductors to be manufactured.

From the above, a soft dilute-copper alloy material having a good balance between elongation characteristics, tensile strength and Vickers hardness can be obtained as a raw material of the soft dilute-copper alloy insulated twisted wire formed using the soft dilute-copper alloy wires in the invention.

In addition, although a wire rod is made by the SCR continuous casting and rolling method and a soft material is made by the hot rolling in the invention, a twin-roll continuous casting and rolling method or a Properzi continuous casting and rolling method may be used.

Insulating Cover Layer

The soft dilute-copper alloy wire having the above-mentioned structure is formed by the above-mentioned manufacturing method and is subsequently drawn, thereby forming a thin wire. The wire diameter depends on electric current to be passed therethrough, frequency and twisting characteristics, etc., and is in a range of about 50 μm to 1 mm. If the wire is thinner than this range, a ratio of the insulating cover layer to the cross sectional area becomes large and this causes reduction in the amount of current which can flow therethrough. In addition, it becomes more difficult to control quality during the manufacturing and this causes an increase in cost, hence, it is not industrially practical. On the other hand, in case of the thicker wire, a large load caused by twisting is applied to the wires at the time of twisting and the finished product is difficult to handle. Furthermore, when a high-frequency current is applied, the current flows through only a surface at higher frequency due to the skin effect and this causes a problem of deterioration in efficiency of the conductor.

The material of the insulating cover layer can be selected from known materials depending on the intended use and desired insulation performance and is not limited. Examples of wires using such known materials include formal enameled wires, polyurethane enameled wires, polyester enameled wires, polyester-imide enameled wires, polyamide-imide enameled wires and polyimide enameled wires, etc., as well as composite coating enameled wires covered with two or more types of materials. Furthermore, self-bonding coating material or self-lubricant coating material may be further applied to the outer periphery of the insulating cover layer.

As a method of manufacturing the insulating cover layer, known methods are applicable and it is possible to employ a method in which a wire is immersed in a coating material and a coating material with a predetermined thickness is attached by passing the wire through a die with an appropriate gap around the wire and is bound by drying or baking. In addition, it is also possible to employ a method in which an insulating cover layer is provided by extruding the coating material together with the conductor.

Method of Manufacturing Twisted Wire

The soft dilute-copper alloy insulated twisted wire of the invention is formed by twisting plural soft dilute-copper alloy insulated wires together. The number of wires to be twisted together is not limited but is often seven as shown in FIG. 1 or nineteen because it is easy to manufacture.

Twisting can be carried out by a known method and it is possible to use a commercially available wire twisting machine. In addition, it is possible to form a soft dilute-copper alloy insulated twisted wire by further twisting such twisted wires together.

Although work hardening occurs in the conductors at the time of further twisting, heat treatment can be carried out after forming the twisted wire within the range not affecting the insulating cover layer. The soft dilute-copper alloy material used for the soft dilute-copper alloy insulated twisted wire in the invention can be softened at lower temperature than conventional conductors, and thus can be softened without using extremely high heat resistant coating material.

### Example 1

### 0.26 mm-Diameter Soft Dilute-Copper Alloy Wire

8 mm-diameter copper wires (wire rods, a compression ratio of 99.3%) containing low-oxygen copper (oxygen concentration of 7 mass ppm to 8 mass ppm and sulfur concentration of 5 mass ppm) with a titanium concentration of 13 mass ppm were made as experimental materials. The 8 mm-diameter copper wires have been hot rolled by SCR (South Continuous Rod System) continuous casting and rolling method. Molten copper which was melted in a shaft furnace was poured into a gutter under a reductive gas atmosphere, the molten copper poured into the gutter was introduced into a casting pot under the same reductive gas atmosphere, and Ti was added in the casting pot, and subsequently, an ingot rod was made in a casting mold formed between a casting wheel and an endless belt by sending the resulting molten copper through a nozzle. The 8 mm-diameter copper wire was made by hot rolling the ingot rod.

Next, Example Material 1 was obtained as follows. The experimental material was cold-drawn to have a diameter of 2.6 mm and electric annealing was carried out once. After that, the wire was further drawn to have a diameter of 0.9 mm and electric annealing was carried out again, thereby making a 2.6 mm-diameter copper wire. Then, the wire was annealed at an annealing temperature of 600° C. for 1 hour, thereby obtaining Example Material 1.

Meanwhile, Comparative Material 1 was obtained as follows. An 8 mm-diameter copper wire was cold-drawn to have a diameter of 2.6 mm and electric annealing was carried out once. After that, the wire was further drawn to have a diameter of 0.9 mm and electric annealing was carried out again, thereby making a 2.6 mm-diameter copper wire. Then, the wire was annealed at an annealing temperature of 600° C. for 1 hour, thereby obtaining Comparative Material 1.

Firstly, the crystal structures of these wires were evaluated.

FIG. 2 is a photograph showing a sectional structure across-the-width of Example Material 1 and FIG. 3 is a photograph showing a sectional structure across-the-width of Comparative Material 1.

As shown in FIGS. 2 and 3, crystal grains having an equal size all around are uniformly aligned from the surface to the middle portion in the crystal structure of Comparative Material 1. In contrast, the size of crystal grain in the crystal structure of Example Material 1 is uneven as a whole and what is notable here is that a crystal grain size in a thin layer formed on the wire near the surface in a cross-sectional direction is extremely smaller than that of inner side.

The inventors consider that a fine crystal grain layer appeared as a surface layer, which is not formed in Comparative Material 1, contributes to improve tensile strength and elongation characteristics of Example Material 1.

It is generally understood that uniformly coarsened crystal grains are formed by recrystallization as is in Comparative Material 14 if annealing treatment is carried out at an annealing temperature of 600° C. for 1 hour. However, a fine crystal grain layer remains as a surface layer in Example Material 1 even after the annealing treatment at the annealing temperature of 600° C. for 1 hour and it is therefore considered that a soft dilute-copper alloy material, which is a soft copper material but can realize good tensile strength and elongation characteristics of a below-described copper conductor, is obtained.

Then, an average crystal grain size in the surface layer of Example Material 1 and that of Comparative Material 1 were measured based on the cross-sectional images of the crystal structures shown in FIGS. 2 and 3.

Here, as a method of measuring an average crystal grain size in the surface layer, the crystal grain size was measured on a line within 1 mm in length from a surface of a 0.26 mm-diameter radial cross section up to a depth of 50 μm (about 20% of wire diameter) at intervals of 10 μm in a depth direction, as shown in FIG. 4. And an average of the actual measured values of the crystal grain size was defined as an average crystal grain size in the surface layer.

As a result of the measurement, the average crystal grain size in the surface layer of Comparative Material 1 was 50 μm, and is largely different from that of Example Material 1 which was 10 μm. It is believed that good tensile strength and elongation characteristics of the below-described copper conductor are realized since the average crystal grain size in the surface layer is fine.

### Example 2

### Crystal Structure of 0.26 mm-Diameter Soft Dilute-Copper Alloy Wire Annealed at 400° C.

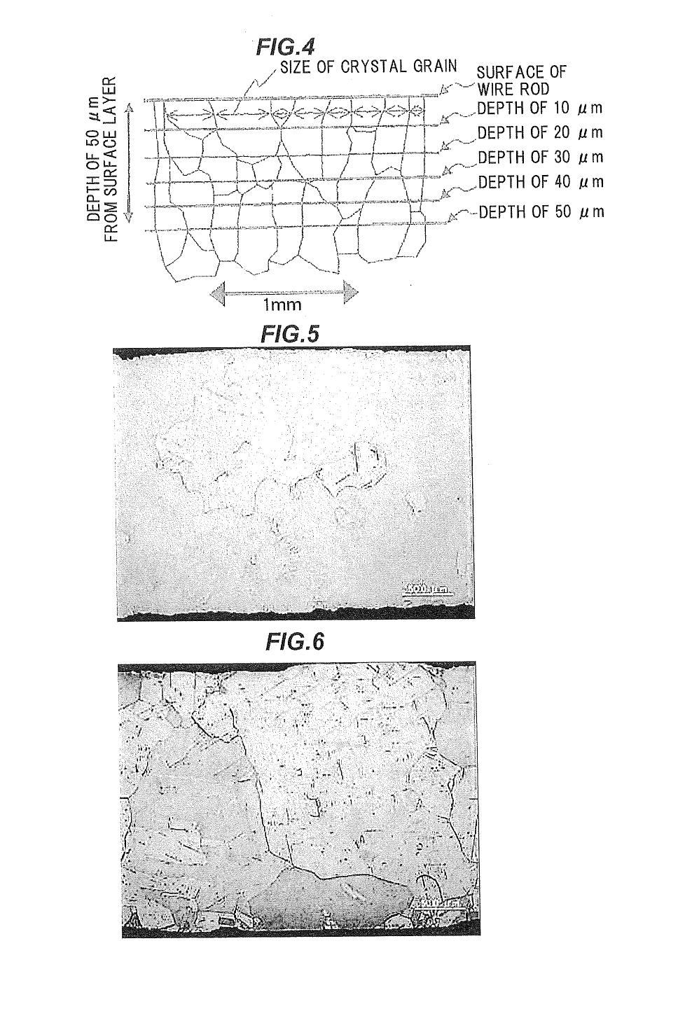

FIG. 5 is a photograph showing a sectional structure across-the-width of the sample of Example Material 2 and FIG. 6 is a photograph showing a sectional structure across-the-width of Comparative Material 2.

Example Material 2 is formed based on Example Material 1 but the final annealing temperature is changed from 600° C. to 400° C. Comparative Material 2 is formed based on Comparative Material 1 but the final annealing temperature is changed from 600° C. to 400° C.

As shown in FIGS. 5 and 6, it is understood that crystal grains having an equal size all around are uniformly aligned from the surface to the middle portion in the crystal structure of Comparative Material 2. In contrast, the crystal structure of Example Material 2 has a difference in the size of crystal grain between the surface layer and the inner side, such that a crystal grain size of the inner side is extremely larger than that in the surface layer.

When copper is annealed to recrystallize the crystal structure, recrystallization is likely to proceed and the crystal grains of the inner side thus grow to be large in Example Material 2.

Next, conductivity of Example Material 2 and that of Comparative Material 2 are shown in Table 1.

TABLE 1

| | Conductivity of Soft |
|---|---|
| Samples | material (% IACS) |
| Example Material 2 | 102.4 |
| Comparative Material 2 | 101.8 |

As shown in Table 1, Example Material 2 has higher conductivity (102.4% IACS) than that of Comparative Material 2 (101.8% IACS) and is satisfactory enough to be used for even a litz wire.

### Example 3

### 0.05 mm-Diameter Soft Dilute-Copper Alloy Wire

The procedure to make a 0.9-mm diameter copper wire is the same as that for Example Material 1 formed of the soft dilute-copper alloy material. Then, the copper wire was drawn to have a diameter of 0.05 mm, thereby obtaining Example Material 3.

The soft dilute-copper alloy material drawn from 0.9 mm to 0.05 mm in diameter was annealed by running in a tubular furnace at 400° C. to 600° C. for 0.8 to 4.8 seconds, thereby making a sample of Example Material 3. For the purpose of comparison, oxygen-free copper (OFC with a purity of not less than 99.99%) having a diameter of 0.05 mm was made under the same thermomechanical treatment conditions, thereby making a sample of Comparative Material 3.

Mechanical characteristics (tensile strength, elongation), hardness and crystal grain size of the samples were measured. To derive the average crystal grain size in the surface layer, the crystal grain size on a line within 0.025 mm in length from a surface of a widthwise cross section of a 0.05 mm diameter up to a depth of 10 μm in a depth direction was measured.

Softening Characteristics, Elongation and Tensile Strength of Copper Conductor

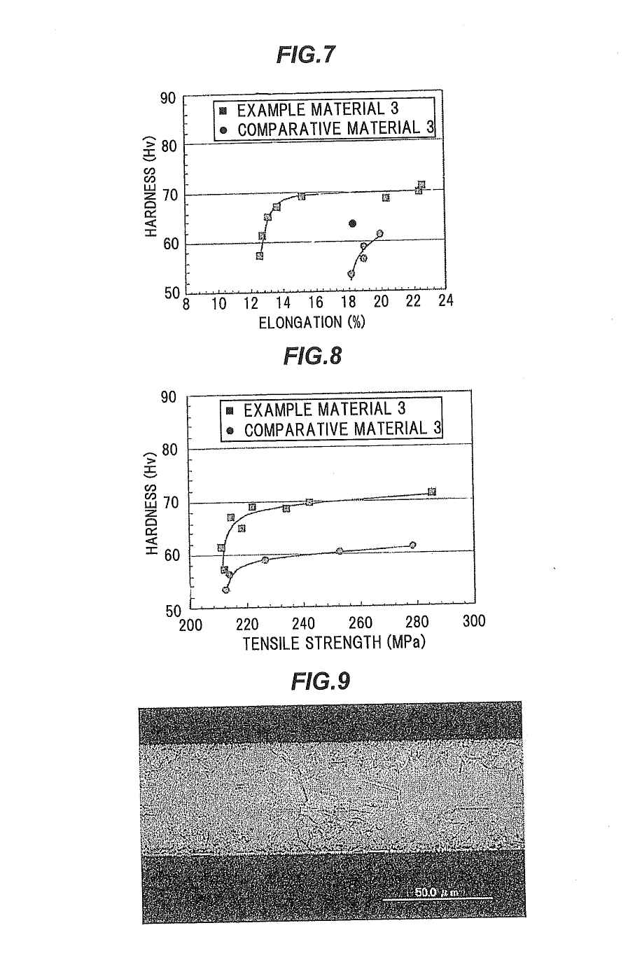

FIGS. 7 and 8 show the results of cross-sectional hardness (Hv) and mechanical characteristics (tensile strength and elongation) measured on Comparative Material 3 using an oxygen-free copper wire and Example Material 3 formed of a soft dilute-copper alloy wire containing low-oxygen copper and 13 mass ppm of Ti, which have been drawn from 0.9 mm (annealed material) to 0.05 mm in diameter and annealed by running in a tubular furnace (temperature: 300° C. to 600° C., annealing time: 0.8 to 4.8 seconds).

For evaluating the cross-sectional hardness, a horizontal section of the 0.05 mm-diameter copper conductor embedded in a resin was polished and Vickers hardness at the center portion of the copper conductor was measured. The number of measurements (n) is 5 (n=5) and the average value thereof is defined as the cross-sectional hardness.

Tensile strength and elongation were measured and evaluated by conducting a tensile test on the 0.05 mm-diameter copper conductor under the conditions of a gage length of 100 mm and a tension rate of 20 mm/min. The maximum tensile stress at which the material is fractured is defined as tensile strength, and the maximum deformation volume (strain) at which the material is fractured is defined as elongation.

As shown in FIG. 7, it is understood that Example Material 3 has tensile strength 15 MPa or more greater than that of Comparative Material 3 when compared at substantially the same elongation percentage. It is possible to increase tensile strength without decreasing the elongation as compared to oxygen-free copper and this allows, e.g., wire breakage caused by stress application to be more reduced in the copper conductor of Example Material 3 than in the conductor of Comparative Material 3 using oxygen-free copper.

The data under the conditions in which the hardness of Example Material 3 is substantially equal to that of Comparative Material 3 is extracted from the evaluation results shown in FIG. 7, and comparison of the results is shown in Table 2. In the upper row, Table 2 shows mechanical characteristics and hardness of Example Material 3 which was drawn from 0.9 mm (annealed material) to 0.05 mm in diameter and was annealed by running in a tubular furnace at 400° C. for 1.2 seconds. Likewise, in the lower row, Table 2 shows mechanical characteristics and hardness of Comparative Material 3 which was drawn from 0.9 mm (annealed material) to 0.05 mm in diameter and was annealed by running in a tubular furnace at 600° C. for 2.4 seconds.

TABLE 2

| | | Elongation | |
|---|---|---|---|
| | Tensile | Percentage | Vickers hardness |
| Samples | strength (MPa) | (%) | (Hv) |
| Example Material 3 | 279 | 20 | 61 |
| Comparative Material 3 | 211 | 13 | 61 |

Table 2 reveals a difference between the materials having the same hardness such that Example Material 3 has elongation 7% higher than Comparative Material 3 and also higher tensile strength than oxygen-free copper having the same hardness.

Next, it is understood from FIG. 8 that the hardness of Example Material 3 is about 10 Hv smaller than that of Comparative Material 3 when compared at substantially the same tensile strength. It is possible to reduce the hardness without decreasing the tensile strength, resulting in a flexible wire.

The data under the conditions in which the tensile strength of Example Material 3 is substantially equal to that of Comparative Material 3 is extracted and comparison of the results is shown in Table 3. In the upper row, Table 3 shows mechanical characteristics and hardness when Example Material 3 which was drawn from 0.9 mm (annealed material) to 0.05 mm in diameter and was annealed by running in a tubular furnace at 500° C. for 4.8 seconds. Likewise, in the lower row, Table 3 shows mechanical characteristics and hardness when of Comparative Material 3 which was drawn from 0.9 mm (annealed material) to 0.05 mm in diameter and was annealed by running in a tubular furnace at 600° C. for 2.4 seconds.

TABLE 3

| | | Elongation | |
|---|---|---|---|
| | Tensile | Percentage | Vickers hardness |
| Samples | strength (MPa) | (%) | (Hv) |
| Example Material 3 | 213 | 18 | 53 |
| Comparative Material 3 | 211 | 13 | 61 |

As shown in Table 3, it is understood that the elongation of Example Material 3 is 5% higher than Comparative Material 3 even though the both materials have the same tensile strength, and a wire of Example Material 3 is thus excellent in reliability and handling properties.

Reliability here means resistance against breakage or springback of the wire at the time of twisting. Handling properties mean wiring properties after being formed into a litz wire or ease of winding at the time of forming a coil.

The balance among tensile strength, elongation and hardness is somewhat different depending on technical specifications required for products, and as an example, the invention can provide a conductor having a tensile strength of not less than 270 MPa, elongation percentage of not less than 7% and hardness of not more than 65 Hv when considering that the tensile strength is important, and can provide a conductor having a tensile strength of not less than 210 MPa and less than 270 MPa, an elongation percentage of not less than 15% and a hardness of not more than 63 Hv when considering that small hardness is additionally important.

The running annealing in a tubular furnace (temperature: 300° C. to 600° C., time: 0.8 to 4.8 seconds) is carried out to anneal 0.05 mm-diameter wires of Example Material 3 in the invention and Comparative Material 3. Meanwhile, use of an electric annealer also provides the similar effects such that tensile strength is high at the same elongation and Vickers hardness is small at the same tensile strength. This shows that, regardless of the annealing method, Example Material has excellent material properties as a conductor used for a litz wire, as compared to Comparative Material.

Crystal Structure of 0.05 mm-Diameter Soft Dilute-Copper Alloy Wire

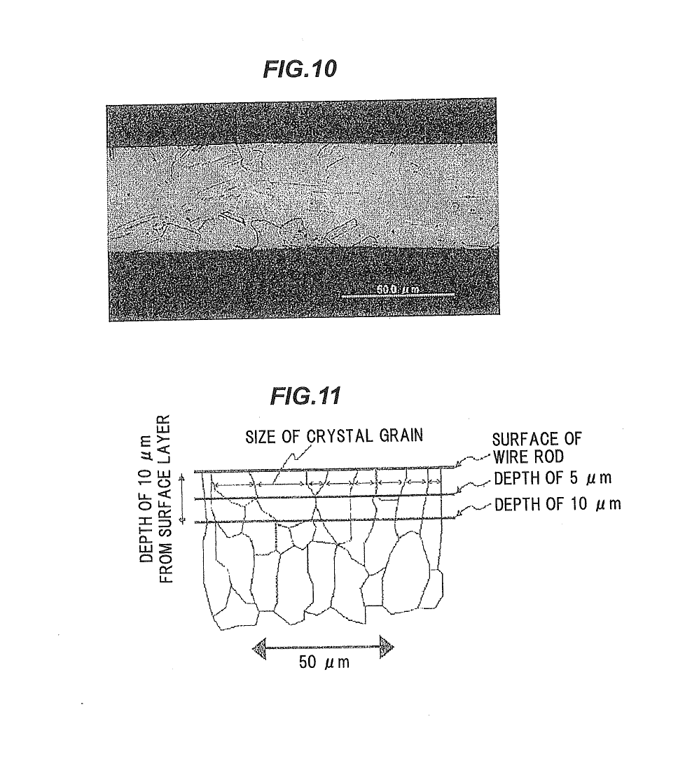

FIG. 9 shows a cross sectional structure across-the-width of Example Material 3 and FIG. 10 shows a cross sectional structure across-the-width of Comparative Material 3.

It is understood that crystal grains having an equal size all around are uniformly aligned from the surface to the middle portion in the crystal structure of Comparative Material 3. In contrast, the size of crystal grain in the crystal structure of Example Material 3 is uneven as a whole, and a crystal grain size in a thin layer formed on the sample near the surface in a cross-sectional direction is extremely smaller than that of inner side.

The inventors consider that a fine crystal grain layer appeared as a surface layer of Example Material 3, which is not formed in Comparative Material 3, contributes to having softening characteristics of Example Material 3 and achieving both of tensile strength and elongation characteristics.

In general, it is understood that uniformly coarsened crystal grains are formed by recrystallization as is in Comparative Material 3 if heat treatment is carried out for the purpose of softening. However, a fine crystal grain layer remains as a surface layer in Example Material 3 even after the annealing treatment for forming the coarsened crystal grains in the inner side. It is therefore considered that the soft dilute-copper alloy material of Example Material 3 is excellent in tensile strength and elongation even though it is a soft copper material.

The average crystal grain size in the surface layer of the sample Example Material 3 and that of Comparative Material 3 were measured based on the cross-sectional images of the crystal structures shown in FIGS. 9 to 10.

FIG. 11 schematically shows a method of measuring an average crystal grain size in the surface layer. A crystal grain size was measured on a line within 0.25 mm in length from a surface of a widthwise cross section of a 0.05 mm diameter up to a depth of 10 μm at intervals of 5 μm in a depth direction, as shown in FIG. 11. Then, an average of the measured values (actual measured values) was derived and was defined as an average crystal grain size.

As a result of the measurement, while the average crystal grain size in the surface layer of Comparative Material 3 was 22 μm, Example Material 3 had different average crystal grain sizes in the surface layer which were 7 μm and 15 μm. One of the reasons why high tensile strength and elongation were obtained is believed that the average crystal grain size in the surface layer is fine. Cracks are developed along a crystal grain boundary when the crystal grain size is large. However, the development of cracks is suppressed when the crystal grain size is small since a developing direction of cracks is changed. It is thus considered that fatigue characteristics of Example Material 3 are better than those of Comparative Material 3. The fatigue characteristics mean the number of stress application cycles or time until the material is fractured when receiving stress repeatedly.

In order to achieve the effects of the present example, the average crystal grain size in the surface layer is preferably not more than 15 μm.

Since the soft dilute-copper alloy wire in the present embodiment is formed of the soft dilute-copper alloy material containing Ti, etc., with copper as the balance and having a crystal structure with an average crystal grain size of not more than 20 μm in the surface layer from the surface to a depth of at most 20% of the wire diameter, high tensile strength and high elongation are both achieved and also high conductivity is obtained, which allow reliability of products to be enhanced.

In addition, since S (sulfur) as an impurity is also trapped by the additive elements selected from the group consisting of Mg, Zr, Nb, Ca, V, Ni, Mn and Cr in the same manner as Ti, matrix of copper is highly purified and softening characteristics of a raw material are improved.

Furthermore, since the soft dilute-copper alloy material in the present embodiment can realize high conductivity using a cheap continuous casting and rolling method without necessity of process of highly purifying copper (not less than 99.999 mass %), it is possible to reduce the cost.

Insulated Twisted Wire

Using the same materials and processes to make Example Materials 1 and 2, a soft dilute-copper alloy wire having a conductor diameter of 0.26 mm was made. Further annealing was performed on the wire at an annealing temperature of 400° C. and an insulation layer as an insulating cover was formed thereon by applying and baking 20 μm of polyamide-imide resin. Seven wires were prepared and were concentrically twisted by a wire twisting machine at a twisting pitch of 20 mm, thereby obtaining is a litz wire as Example Material 4. Comparative Material 4 formed by the same process but using tough pitch copper as a conductor was prepared for the purpose of comparison.

Characteristics were evaluated based on external observation of the litz wire and evaluation of Vickers hardness after separating into individual wires.

TABLE 4

| Samples | External appearance | Vickers hardness (Hv) |
|---|---|---|
| Example Material 4 | Fine | 61 |
| Comparative Material 4 | Fine | 105 |

As shown in Table 4, appearance is not different between Example Material 4 and Comparative Material 4 and this shows that Example Material can be used for an enameled wire. Vickers hardness of the wire is 61 Hv in Example Material 4 and 105 Hv in Comparative Material 4, which shows that Example Material 4 is significantly softer than Comparative Material 4. It is slightly harder than the wires of Example Materials 1 to 3 due to work hardening at the time of applying the insulating film, twisting, or detaching the wire during the measurement. As such, the insulated twisted wire of the invention also maintains inherent superiority over Comparative Material, and it is therefore a wire which is excellent in reliability and handling properties even if used as a litz wire.

What is claimed is:

1. A soft dilute-copper alloy insulated twisted wire, comprising a plurality of insulated wires twisted together and each comprising a conductor and an insulating cover layer thereon,
wherein the conductor comprises a soft dilute-copper alloy wire comprising a soft dilute-copper alloy material comprising an additional element selected from the group consisting of Ti, Mg, Zr, Nb, Ca, V, Ni, Mn and Cr with a balance consisting a copper and an inevitable impurity, and
wherein an average crystal grain size in a region from a surface of the soft dilute-copper alloy wire to a depth of at least 20% of a wire diameter is not more than 20 μm.

2. The soft dilute-copper alloy insulated twisted wire according to claim 1, wherein the soft dilute-copper alloy material comprises more than 2 mass ppm of oxygen and not less than 2 mass ppm and not more than 12 mass ppm of sulfur.

3. The soft dilute-copper alloy insulated twisted wire according to claim 1, wherein the soft dilute-copper alloy material has a tensile strength of not less than 210 MPa, an elongation percentage of not less than 15% and a Vickers hardness of not more than 65 Hv.

4. The soft dilute-copper alloy insulated twisted wire according to claim 1, wherein the soft dilute-copper alloy material has a conductivity of not less than 98% IACS.

5. The soft dilute-copper alloy insulated twisted wire according to claim 1, wherein the soft dilute-copper alloy material comprises not less than 4 mass ppm and not more than 55 mass ppm of Ti as the additive element and more than 2 mass ppm and not more than 30 mass ppm of oxygen.

6. The soft dilute-copper alloy insulated twisted wire according to claim 1, wherein a plurality of the soft dilute-copper alloy wires each comprising an insulating cover layer are twisted together and another insulation cover layer is further formed on the outer periphery thereof.

7. A coil, comprising the soft dilute-copper alloy insulated twisted wire according to claim 1 and a coil shape.
